(19) United States
(12) Patent Application Publication
(10) Pub. No.: US 2011/0151424 A1
(43) Pub. Date: Jun. 23, 2011

(54) METHOD AND APPARATUS FOR GENERATING ELECTRONIC TRAINING JACKETS

(75) Inventors: Giacomo BISCOTTI, Chesapeake, VA (US); Michael BOBINGER, Yorktown, VA (US); Mark Andrew COOPER, Elkridge, MD (US); Howard McGRATH, Lusby, MD (US); Kevin KJOSE, Hollywood, MD (US); Susan HITCHINS, Solomons, MD (US)

(73) Assignee: ARINC INCORPORATED, Annapolis, MD (US)

(21) Appl. No.: 12/645,527

(22) Filed: Dec. 23, 2009

(51) Int. Cl. G09B 7/00; G09B 19/00

(52) U.S. Cl. 434/350; 434/219; 434/362

(57) ABSTRACT

A method and apparatus for generating electronic training jackets is disclosed. The method may include receiving a request from a user to generate an electronic training jacket for an individual, retrieving qualification information for the individual from at least one of one or more remote qualification databases and one or more local qualification databases, generating the electronic training jacket from the retrieved qualification information, and automatically outputting the generated electronic training jacket to the user using an output device. The qualification information may be aviation-related and shipboard-related qualification information and the aviation-related and the shipboard-related qualification information may include at least one of medical qualification information, job training qualification information, and education information.

### BACKGROUND OF THE DISCLOSED EMBODIMENTS

1. Field of the Disclosed embodiments

The disclosed embodiments relate to the generation of electronic training jackets.

2. Introduction

Currently, all aviation-related and shipboard-related activities, including the Air Transport Association (ATA), U.S. Armed Forces, Federal Aviation Administration (FAA), Air Traffic Control (ATC), and foreign services, use paper training records to annotate training progress, qualification, and time spent in-position. Often, an individual must meet qualifications within a certain time period to continue working in their position. Keeping the current paper training jacket updated is extremely time consuming and costly endeavor. However, there are currently no electronic training jacket systems that automatically retrieve or track qualification, training, education medical, and other job-related requirements.

### SUMMARY OF THE DISCLOSURE

A method and apparatus for generating electronic training jackets is disclosed. The method may include receiving a request from a user to generate an electronic training jacket for an individual, retrieving qualification information for the individual from at least one of one or more remote qualification databases and one or more local qualification databases, generating the electronic training jacket from the retrieved qualification information, and automatically outputting the generated electronic training jacket to the user using an output device. The qualification information may be aviation-related and shipboard-related qualification information and the aviation-related and the shipboard-related qualification information may include at least one of medical qualification information, job training qualification information, and education information.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is diagram of an exemplary electronic training jacket generation environment in accordance with a possible embodiment of the disclosure;

FIG. 2 is a block diagram of an exemplary electronic training jacket generation unit in accordance with a possible embodiment of the disclosure;

FIG. 3 is an exemplary flowchart illustrating one possible electronic training jacket generation process in accordance with one possible embodiment of the disclosure; and

FIG. 4 is an exemplary electronic training jacket in accordance with a possible embodiment of the disclosure.

### DESCRIPTION OF THE DISCLOSED EMBODIMENTS

Additional features and advantages of the disclosed embodiments will be set forth in the description which follows, and in part will be obvious from the description, or may be learned by practice of the disclosed embodiments. The features and advantages of the disclosed embodiments may be realized and obtained by means of the instruments and combinations particularly pointed out in the appended claims. These and other features of the present disclosed embodiments will become more fully apparent from the following description and appended claims, or may be learned by the practice of the disclosed embodiments as set forth herein.

Various embodiments of the disclosed embodiments are discussed in detail below. While specific implementations are discussed, it should be understood that this is done for illustration purposes only. A person skilled in the relevant art will recognize that other components and configurations may be used without parting from the spirit and scope of the disclosed embodiments.

The disclosed embodiments comprise a variety of embodiments, such as a method and apparatus and other embodiments that relate to the basic concepts of the disclosed embodiments. Note that while this disclosure discusses aircraft-related and shipboard-related uses for the disclosed embodiments, the disclosed embodiments by no means are limited to that technology area and may be applied to a wide variety of environments and uses.

The disclosed embodiments may concern an electronic training jacket generation process may allow aviation-related and shipboard-related activities the opportunity to spend more time in different branches of the facility due to the reduction it takes to update facility training. An electronic training jacket generation may include a database that tracks individual controllers going through the training process at aviation-related and shipboard-related facilities. The process may annotate hours, keeps track of certifications, medical clearances while also providing a career history summary for each controller under a facility or entire organization's umbrella.

Since the electronic training jackets may be in a web-based or network-based database, an organization's management team may keep track of the progress of training at each facility under their jurisdiction. In addition, an organization may have the ability to complete training quality assurance and safety checks by accessing electronic training jacket generation for specific facilities on the web. The electronic training jacket generation process may provide a user-based access control which may allow only certain people to modify individual's electronic training jackets while enabling management to view each individual member or activity's training program's progress.

In this manner, the disclosed embodiments may permit electronic training jacket generation to be a simple, managed activity and provide users of electronic devices with current up-to-date electronic training jackets on their device, such as a portable and/or fixed computing devices including desktop and laptop and other portable computers, to electronic paper (epaper) based document reader devices and other communications enabled display capable devices such as personal digital assistants (PDAs), ultra mobile personal computers (UMPCs) and netbooks.

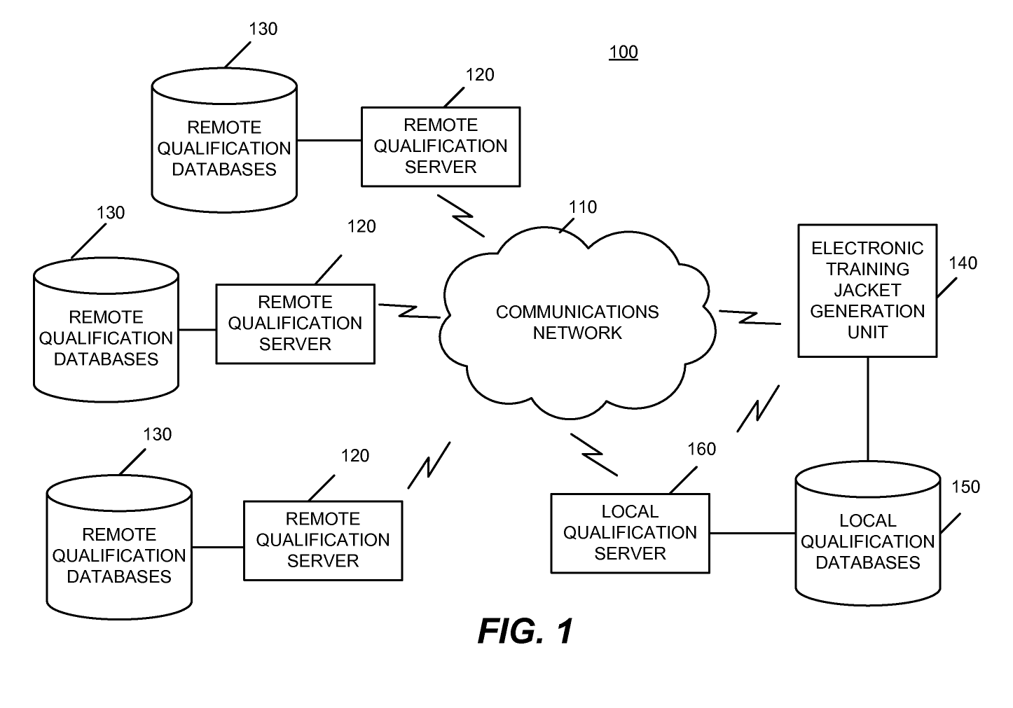

FIG. 1 is diagram of an exemplary electronic training jacket generation environment 100 in accordance with a possible embodiment of the disclosure. The electronic training jacket generation environment 100 may include one or more remote qualification servers 120 and an electronic training jacket generation unit 140 which may be connected through the communications network 110. The one or more remote qualification servers 120 may include or have access to one or more remote qualification databases 130. The electronic training jacket generation unit 140 may include or have access to one or more local qualification databases 150 and be connected to one or more local qualification server s160. The one or more local qualification servers 160 may also have access to the one or more local qualification databases 150 and may communicate directly with the electronic training jacket generation unit 140, for example. Although some of the connections in FIG. 1 are shown as wireless and others as wired configurations, any of these connections may wired or wireless in accordance with techniques known to those of skill in the art.

Communications network 110 may represent any communications network used to communicate with other entities, including the Internet, an intranet, a radio network, a wireless network, etc. The electronic training jacket generation unit 140, the one or more local qualification servers 160, and the one or more remote qualification servers 120 may be any server, computer, processing device, personal digital assistant (PDA), or other similar device capable of storing, managing and presenting electronic qualification information.

The one or more local qualification databases 150 and the one or more remote qualification databases 130 may be any database stored in a memory that contains qualification information. The qualification information may be aviation-related and shipboard-related qualification information. The aviation-related and the shipboard-related qualification information may include at least one of medical qualification information, job training qualification information, education information, etc., for example.

More specifically, aviation-related qualification information may be military or civilian qualification information including aircraft qualifications, Personal Qualification Standards (PQS), Naval Aviation Training and Operating Procedures Standardization (NATOPS), Air Traffic Control (ATC) qualifications, aviation-related schools, swimming qualifications, medical qualifications (e.g., yearly physical completed), “up” (medically cleared to fly) or “down” (not medically cleared to fly) information, fire-fighting training, parachute qualifications, instrument training, equipment issued, flight hours and type rating, date receiving wings or license and any renewal information, number of landings, number of takeoffs, flight or ATC violations or disciplinary actions, etc.

Shipboard-related qualification information may be military or civilian qualification information including shipboard qualifications, PQS, shipboard-related schools, ship handling qualifications, medical qualifications (e.g., periodic physical completed), ship handling violations or disciplinary actions, rating information, fire fighting training, Surface or Submarine Warfare qualification information, instrument training, etc.

In one possible embodiment, the qualification information may be aviation-related or shipboard-related, for example. However, the qualification information for the disclosed embodiments is not limited to a particular area and may be any possible documents/messages known to one of skill in the art and may include qualification information for any job that may require tracking of qualifications, such as trains/subways, police, fire, rescue, medical, nuclear power, package shipping, environmental, etc.

The one or more local qualification servers 160, and the one or more remote qualification servers 120 may populate the respective one or more local qualification databases 150 and one or more remote qualification databases 130 with individuals' and units' qualification information. The electronic training jacket generation unit 140 may receive qualification information on an individual from one or more local qualification databases 150 and/or one or more remote qualification databases 130 in order to generate an electronic training jacket. The electronic training jacket may be generated by a user have authorization or it may be generated by a user for his or her own purposes (with special authorizations, if necessary).

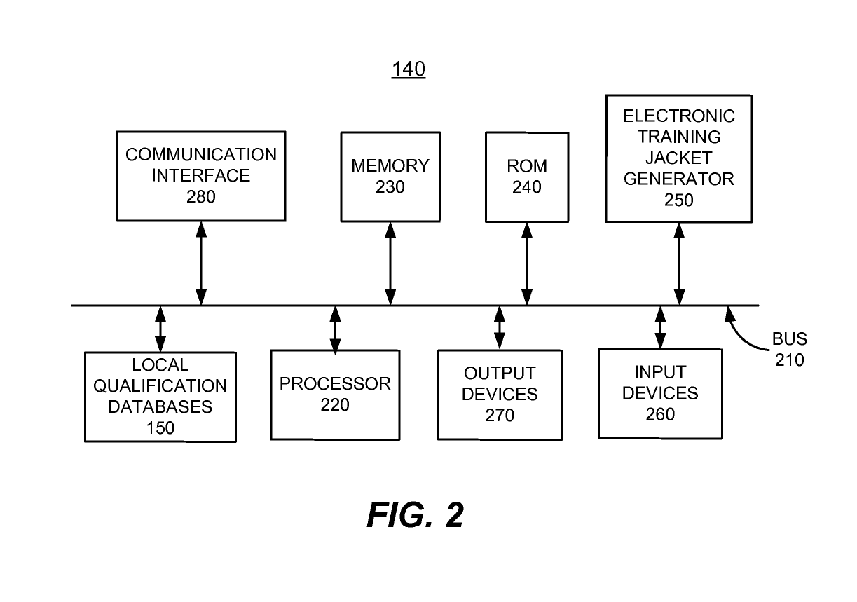

FIG. 2 is a block diagram of an exemplary electronic training jacket generation unit 140 in accordance with a possible embodiment of the disclosure. The exemplary electronic training jacket generation unit 140 may include bus 210, processor 220, memory 230, read only memory (ROM) 240, electronic training jacket generator 250, input devices 260, output devices 270, communication interface 280, and local qualification database 150. Bus 210 may permit communication among the components of the electronic training jacket generation unit 140.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Memory 230 may also represent any storage device that may include any type of media, such as, for example, magnetic or optical recording media and its corresponding drive.

Input devices 260 may include one or more conventional mechanisms that permit a user to input information to the electronic training jacket generation unit 140, such as a keyboard, a mouse, a pen, a voice recognition device, etc. Output devices 270 may include one or more conventional mechanisms that output information to the user, including a display, a printer, one or more speakers, or a medium, such as a memory, or a magnetic or optical disk and a corresponding disk drive.

Communication interface 280 may include any transceiver-like mechanism that enables the electronic training jacket generation unit 140 to communicate via a network. For example, communication interface 280 may include a modem, or an Ethernet interface for communicating via a local area network (LAN). Alternatively, communication interface 280 may include other mechanisms for communicating with other devices and/or systems via wired, wireless or optical connections. In some implementations of the electronic training jacket generation unit 140, communication interface 280 may not be included in the exemplary electronic training jacket generation unit 140 when the content management process is implemented completely within the electronic training jacket generation unit 140.

The local qualification database 150 is discussed above and may be stored in the memory 230 or other storage medium, for example.

The electronic training jacket generation unit 140 may perform such functions in response to processor 220 by executing sequences of instructions contained in a computer-readable medium, such as, for example, memory 230, a magnetic disk, or an optical disk. Such instructions may be read into memory 230 from another computer-readable medium, such as a storage device, or from a separate device via communication interface 280.

The electronic training jacket generation environment 100 and the electronic training jacket generation unit 140 illustrated in FIGS. 1 and 2 and the related discussion are intended to provide a brief, general description of a suitable computing environment in which the disclosure may be implemented. Although not required, the disclosure will be described, at least in part, in the general context of computer-executable instructions, such as program modules, being executed by the electronic training jacket generation unit 140, such as a general purpose computer. Generally, program modules include routine programs, objects, components, data structures, etc. that perform particular tasks or implement particular abstract data types. Moreover, those skilled in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

For illustrative purposes, the operation of the electronic training jacket generator 250 and the electronic training jacket generation process will be described below in relation to the block diagrams shown in FIGS. 1-2.

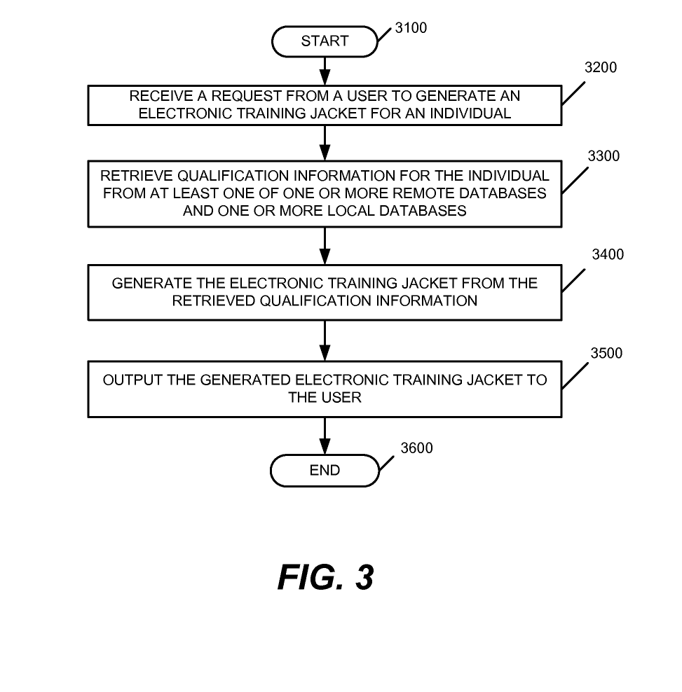

FIG. 3 is an exemplary flowchart illustrating one possible electronic training jacket generation process in accordance with one possible embodiment of the disclosure. The process may begin at step 3100 and may continue to step 3200 where the electronic training jacket generator 250 may receive a request from a user to generate an electronic training jacket for an individual. At step 3300, the electronic training jacket generator 250 may retrieve qualification information for the individual from at least one of one or more remote qualification databases 130 through the communication interface 280 and one or more local qualification databases 150 stored in the memory 230. At step 3400, the electronic training jacket generator 250 may generate the electronic training jacket from the retrieved qualification information. At step 3500, the electronic training jacket generator 250 may automatically output the generated electronic training jacket to the user using an output device 270. The output device 270 may be a printer, an electronic display, etc., and the electronic training jacket may be printed, electronically displayed, conversion to PDF, e-mailed or electronically transmitted to authorized individuals, etc. The electronic training jacket generator 250 may also store the electronic training jacket in the memory 230. The process may then go to step 3600 and end.

The electronic training jacket generator 250 may retrieve one or more qualifications requirements, compare the retrieved qualification requirements to the retrieved qualification information for the individual, identify any deficiency between the retrieved qualification requirements and the retrieved qualification information for the individual, and output any identified deficiency to the user. This output may be in the form of individual deficiency reports for each deficiency, a combined report with multiple deficiencies, or group reports that list deficiencies for units, etc., for example. The reports may be printed, electronically displayed, converted to PDF, e-mailed or electronically transmitted to authorized individuals, etc., for example. In addition, if the electronic training jacket generator 250 identifies no deficiency in the individual's qualifications, the electronic training jacket generator 250 may indicate to the user that the individual has met the retrieved qualification requirements.

The electronic training jacket generator 250 may also send a request to schedule training for the individual based on an identified deficiency through the communication interface 280. The electronic training jacket generator 250 may receive a request to archive an electronic training jacket. In this manner, the electronic training jacket generator 250 may retrieve the electronic training jacket from the memory 230, and send the electronic training jacket to an archive facility through the communication interface 280. The electronic training jacket generator 250 may also automatically update the individual's electronic training jacket on a periodic basis.

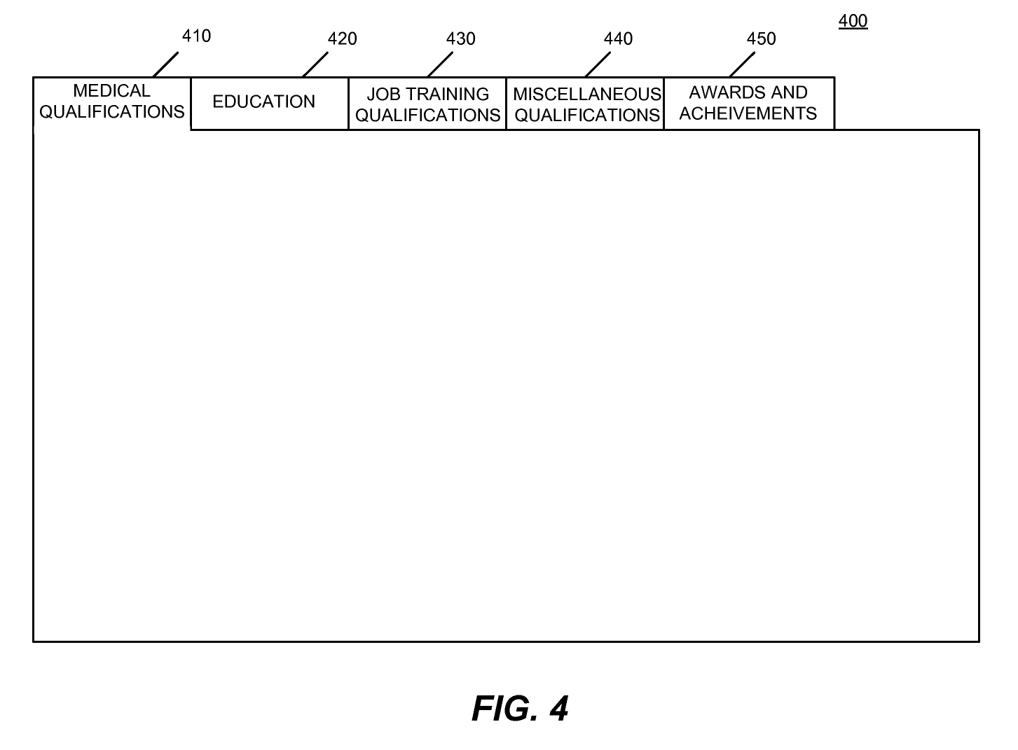

FIG. 4 shows an example of how an electronic training jacket 400 may appears to a user on an output device 270, such as a display. The electronic training jacket 400 may have several sections that may be tabbed, tabled, or listed and may include medical qualifications 410, education 420, job training qualifications 430, miscellaneous qualifications 440, and awards and achievements 450. Many other qualification information categories may exist and the electronic training jacket 400 may be customized to meet any job field where qualifications must be met and tracked.

Embodiments within the scope of the present disclosed embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations are part of the scope of the disclosed embodiments. For example, the principles of the disclosed embodiments may be applied to each individual user where each user may individually deploy such a system. This enables each user to utilize the benefits of the disclosed embodiments even if any one of the large number of possible applications do not need the functionality described herein. In other words, there may be multiple instances of the disclosed system each processing the content in various possible ways. It does not necessarily need to be one system used by all end users. Accordingly, the appended claims and their legal equivalents should only define the disclosed embodiments, rather than any specific examples given.

What is claimed is:

1. A method for generating electronic training jackets, comprising:
receiving a request from a user to generate an electronic training jacket for an individual;
retrieving qualification information for the individual from at least one of one or more remote qualification databases and one or more local qualification databases, wherein the qualification information is one of aviation-related and shipboard-related qualification information and the aviation-related and the shipboard-related qualification information include at least one of medical qualification information, job training qualification information, and education information;
generating the electronic training jacket from the retrieved qualification information; and
automatically outputting the generated electronic training jacket to the user using an output device.

2. The method of claim 1, further comprising:
retrieving one or more qualifications requirements;
comparing the retrieved qualification requirements to the retrieved qualification information for the individual;
identifying any deficiency between the retrieved qualification requirements and the retrieved qualification information for the individual; and
outputting any identified deficiency to the user, otherwise if no deficiency is identified, then indicating to the user that the individual has met the retrieved qualification requirements.

3. The method of claim 2, further comprising:
sending a request to schedule training for the individual based on an identified deficiency.

4. The method of claim 1, further comprising:
storing the electronic training jacket in a memory.

5. The method of claim 4, further comprising:
receiving a request to archive an electronic training jacket;
retrieving the electronic training jacket from the memory; and
sending the electronic training jacket to an archive facility through a communication interface.

6. The method of claim 1, wherein the individual's electronic training jacket is automatically updated.

7. The method of claim 1, wherein the electronic training jackets are generated using one of a server, a computer, a processing device, and a personal digital assistant.

8. An apparatus that generates electronic training jackets, comprising:
a memory;
one or more output devices;
a communication interface; and
an electronic training jacket generator that receives a request from a user to generate an electronic training jacket for an individual, retrieves qualification information for the individual from at least one of one or more remote qualification databases through the communication interface and one or more local qualification databases stored in the memory, generates the electronic training jacket from the retrieved qualification information, and automatically outputs the generated electronic training jacket to the user using the output device,
wherein the qualification information is one of aviation-related and shipboard-related qualification information and the aviation-related and the shipboard-related qualification information include at least one of medical qualification information, job training qualification information, and education information.

9. The apparatus of claim 8, wherein the electronic training jacket generator retrieves one or more qualifications requirements, compares the retrieved qualification requirements to the retrieved qualification information for the individual, identifies any deficiency between the retrieved qualification requirements and the retrieved qualification information for the individual, and output any identified deficiency to the user, otherwise if no deficiency is identified, then the electronic training jacket generator indicates to the user that the individual has met the retrieved qualification requirements.

10. The apparatus of claim 9, wherein the electronic training jacket generator sends a request to schedule training for the individual based on an identified deficiency through the communication interface.

11. The apparatus of claim 8, wherein the electronic training jacket generator stores the electronic training jacket in the memory.

12. The apparatus of claim 11, wherein the electronic training jacket generator receives a request to archive an electronic training jacket, retrieves the electronic training jacket from the memory, and sends the electronic training jacket to an archive facility through the communication interface.

13. The apparatus of claim 8, wherein the electronic training jacket generator automatically updates the individual's electronic training jacket.

14. The apparatus of claim 8, wherein the electronic training jackets are generated using one of a server, a computer, a processing device, and a personal digital assistant.

15. A computer-readable medium storing instructions for controlling a computing device for generating electronic training jackets, the instructions comprising:
receiving a request from a user to generate an electronic training jacket for an individual;
retrieving qualification information for the individual from at least one of one or more remote qualification databases and one or more local qualification databases, wherein the qualification information is one of aviation-related and shipboard-related qualification information and the aviation-related and the shipboard-related qualification information include at least one of medical qualification information, job training qualification information, and education information;
generating the electronic training jacket from the retrieved qualification information; and
automatically outputting the generated electronic training jacket to the user using an output device.

16. The computer-readable medium of claim 15, further comprising:
retrieving one or more qualifications requirements;
comparing the retrieved qualification requirements to the retrieved qualification information for the individual;
identifying any deficiency between the retrieved qualification requirements and the retrieved qualification information for the individual; and
outputting any identified deficiency to the user, otherwise if no deficiency is identified, then indicating to the user that the individual has met the retrieved qualification requirements.

17. The computer-readable medium of claim 16, further comprising:
sending a request to schedule training for the individual based on an identified deficiency.

18. The computer-readable medium of claim 15, further comprising:
storing the electronic training jacket in a memory.

19. The computer-readable medium of claim 18, further comprising:
receiving a request to archive an electronic training jacket;
retrieving the electronic training jacket from the memory; and
sending the electronic training jacket to an archive facility through a communication interface.

20. The computer-readable medium of claim 15, wherein the individual's electronic training jacket is automatically updated.

21. The computer-readable medium of claim 15, wherein the electronic training jackets are generated using one of a server, a computer, a processing device, and a personal digital assistant.
